(19) United States
(12) Patent Application Publication
(10) Pub. No.: US 2025/0342144 A1
(43) Pub. Date: Nov. 6, 2025

(54) DYNAMIC PROPERTY MODIFICATION THROUGH UPDATEABLE ENTITY TAGGING

(71) Applicant: Apple Inc., Cupertino, CA (US)

(72) Inventors: Michael A. GORBACH, Scotts Valley, CA (US); Kenneth A. YORK, San Jose, CA (US); Cameron BURGESS, San Francisco, CA (US)

(21) Appl. No.: 19/063,286

(22) Filed: Feb. 25, 2025

Related U.S. Application Data
(60) Provisional application No. 63/641,952, filed on May 2, 2024.

(51) Int. Cl. G06F 16/22

(52) U.S. Cl. CPC G06F 16/2272

(57) ABSTRACT

The subject technology provides for dynamic property modification through updateable entity tagging by an intelligent automated assistant. An apparatus can extract a schema associated with an application, the schema comprising metadata that defines a structure indicating at least one entity and at least one app intent call. The apparatus determines that the metadata indicates that a property associated with the at least one entity is updateable. The apparatus generates a mapping between the property and the at least one app intent call to indicate a relationship between an action taken by the at least one app intent call to enable modification of the property. The apparatus generates a dictionary structure comprising an indication of the mapping between the property and the at least one app intent call. The apparatus provides the dictionary structure for access by an automated assistant.

### CROSS-REFERENCE TO RELATED APPLICATION(S)

This application claims the benefit of U.S. Provisional Application Ser. No. 63/641,952, entitled “DYNAMIC PROPERTY MODIFICATION THROUGH UPDATEABLE ENTITY TAGGING,” and filed on May 2, 2024, the disclosure of which is expressly incorporated by reference herein in its entirety.

### TECHNICAL FIELD

The present disclosure generally relates to intelligent automated assistants and, more particularly, to dynamic property modification through updateable entity tagging by an intelligent automated assistant.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user. Digital assistants often run on electronic devices with a large number of different applications allowing a user to perform any number of different tasks.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 is a flow chart of an example process that may be performed for dynamic property modification through updateable entity tagging in accordance with one or more implementations.

FIG. 3 is a block diagram illustrating the network environment implementing a digital assistant in accordance with one or more implementations.

FIG. 4 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Software applications often function as closed systems, displaying content visually but lacking meaningful accessibility to the system. Application programming interfaces (APIs) can establish direct communication channels between different software components. The APIs may expose various functions, methods, and data structures that developers can use to interact with and control the behavior of applications. APIs provide a standardized interface for interacting with software systems, allowing developers to access specific functionalities or data without needing to understand the internal workings of the system. This enables automation, integration with other systems, and the development of software tools that enhance productivity and efficiency. However, legacy approaches often relied on manual scripting, which posed challenges in terms of scalability and operational efficiency.

The subject technology introduces a framework that improves the programmable accessibility of software applications on an electronic device. The subject technology tackles these challenges by enabling compatibility with digital assistants and intelligent systems. Independent of legacy approaches, such as manually authored scripts, these advanced systems interact directly with applications by invoking intents, providing a structured means for interacting with applications. An intent represents a specific, clearly defined operation that an application can perform, such as displaying images based on given parameters, retrieving data from its internal storage, or simulating user actions like button clicks or form submissions. Intents can serve as a standardized way of expressing user intentions or system commands, allowing applications to understand and respond to them consistently. This represents a shift towards digital assistants and intelligent systems becoming the primary interfaces for interacting with applications, thereby reducing reliance on user-authored scripts. This compatibility may involve exposing application functionalities as intents through APIs, allowing digital assistants and intelligent systems to understand and execute user requests or commands within the applications.

The subject technology provides various benefits, such as increased efficiency achieved through automated interactions, improved scalability enabled by the option for custom intent development, and enhanced consistency across diverse applications, resulting in a better user experience. These benefits can be realized using standardized communication protocols and APIs, allowing for seamless integration and interoperability between different software components. The subject technology may further provide for automation of mapping between entity properties and app intent calls to execute property modifications automatically, reducing manual effort and streamlining processes.

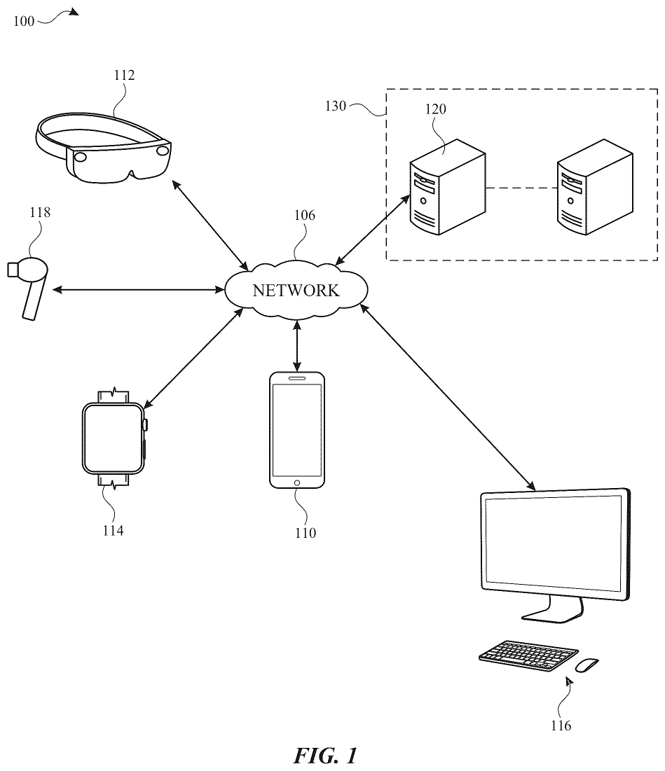

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, an electronic device 118, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, the electronic device 118, and the server 120; however, the network environment 100 may include any number of electronic devices and any number of servers or a data center including multiple servers.

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 10.

The electronic device 112 may be, for example, a desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 10.

The electronic device 114 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 10.

The electronic device 116 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 10.

The electronic device 118 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 118 is depicted as an earphone. The electronic device 118 may be, and/or may include all or part of, the electronic system discussed below with respect to FIG. 10.

In one or more implementations, one or more of the electronic devices 110-118 may provide a system for training a machine learning model using training data, where the trained machine learning model is subsequently deployed to one or more of the electronic devices 110-118. Further, one or more of the electronic devices 110-118 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-118 may be performed entirely on the electronic devices 110-118, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-118. In an implementation, the server 120 may train a given machine learning model for deployment to a client electronic device (e.g., the electronic device 110, the electronic device 112, the electronic device 114, the electronic device 116, the electronic device 118). In one or more implementations, the server 120 may train portions of the machine learning model that are trained using (e.g., anonymized) training data from a population of users, and one or more of the electronic devices 110-118 may train portions of the machine learning model that are trained using individual training data from the user of the electronic devices 110-118. The machine learning model deployed on the server 120 and/or one or more of the electronic devices 110-118 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

In one or more implementations, the network environment 100 integrates a digital assistant, which may operate on any one of electronic devices 110-118 and/or servers 120 within the group of servers 130. A digital assistant, also known as a virtual assistant or intelligent automated assistant, refers to a system that interprets natural language input, either spoken or textual, to understand user intent and execute corresponding actions. These actions may include identifying a task flow tailored to achieve a user's intent, inputting necessary requirements into the task flow, executing the task flow by utilizing various programs, methods, services, APIs, etc., and providing output responses to the user, which can be audible (such as speech) and/or visual.

A digital assistant can understand user requests expressed in natural language, such as commands, statements, or inquiries, seeking either information or task execution. A satisfactory response entails providing the requested information, performing the requested task, or both. For instance, a user may ask for their current location, to which the digital assistant responds with the location information. Alternatively, the user may request a task, like sending invitations for an event, which the digital assistant can accomplish by interacting with the user's electronic address book. These interactions may involve multiple exchanges over time. The digital assistant can respond verbally or through various visual or audio forms, like text, alerts, music, videos, or animations.

The digital assistant can take on tasks typically performed by users, altering the actions within software applications. The digital assistant can generate non-executable programmable code that is structured to align directly with application intents. In this regard, the digital assistant can generate code that interacts with programmer-developed code, establishing a direct link between an artificial intelligence (AI) system and any application, including third-party applications. This integration enables the digital assistant to seamlessly interact with various applications, expanding its functionality across different platforms.

Embodiments of the subject technology provide for a framework that incorporates the concept of updatable entities and mutable properties corresponding to applications. These entities are associated with actions within an application, like creating a new tab in a web browser, a function that may be often used by a digital assistant. This framework can include integrating actions and entities into a ‘get-set’ structure, linking the entity holding information with the action modifying it. Mutable entities allow for altering specific aspects, such as the flag state of a message in an email system, where messages can be flagged in various colors. The action to modify the flag state of a message and the message entity itself, which includes properties like flag status or color, can be interconnected by way of this framework. This integration streamlines the process of updating entity properties through associated actions.

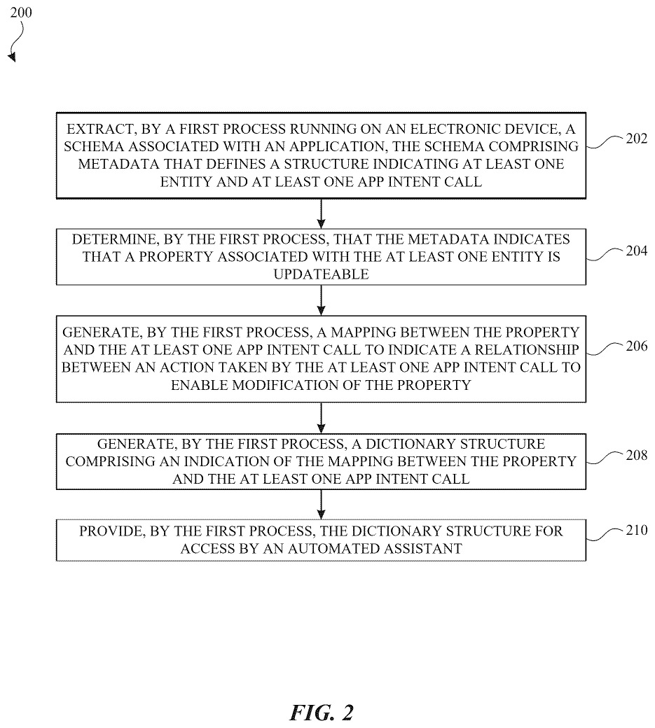

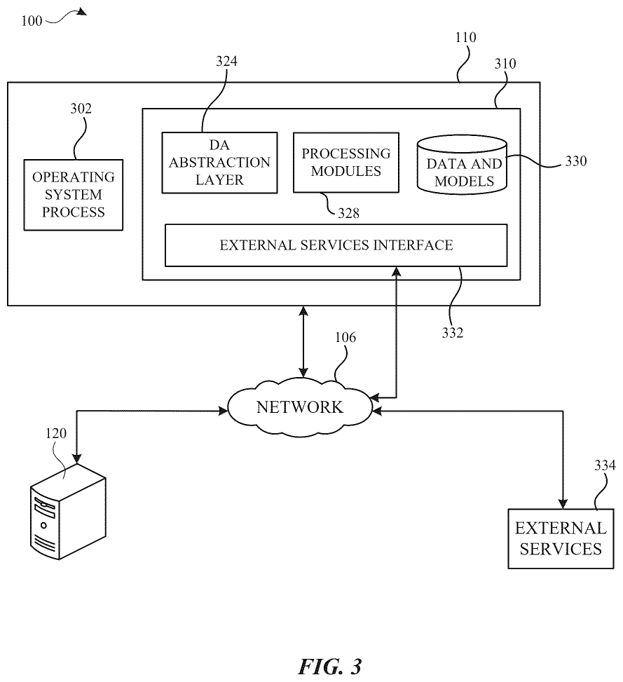

FIG. 2 is a flow chart of an example process that may be performed for dynamic property modification through updateable entity tagging in accordance with one or more implementations. For explanatory purposes, the process 200 is primarily described herein with reference to the electronic device 110 of FIG. 1. However, the process 200 is not limited to the electronic device 110 of FIG. 1, and one or more blocks (or operations) of the process 200 may be performed by one or more other electronic devices (e.g., electronic devices 112-118), other components of other suitable devices and/or servers (e.g., server 120). Further for explanatory purposes, some of the blocks of the process 200 are described herein as occurring in serial, or linearly. However, multiple blocks of the process 200 may occur in parallel. In addition, the blocks of the process 200 need not be performed in the order shown and/or one or more blocks of the process 200 need not be performed and/or can be replaced by other operations. For purposes of brevity in explanation, aspects of the process 200 will be discussed with reference to FIG. 3.

FIG. 3 is a block diagram illustrating the system and environment for implementing a digital assistant in accordance with one or more implementations. As shown in FIG. 3, in some examples, the electronic device 110 includes operating system process 302 and implements a digital assistant as a standalone application installed on the electronic device 110. The digital assistant includes digital assistant portion 310 (hereafter “DA portion 310”) executed on a user device (e.g., electronic devices 110-118). In one or more implementations, DA portion 310 is a process running on the user device. DA portion 310 provides end-user functionalities such as user-facing input and output processing and communication with the server 120.

In one or more implementations, the DA portion 310 includes DA abstraction layer 324, processing modules 328, data and models 330, and external services interface 332. The processing modules 328 can utilize data and models 330 to process speech input and determine a user's intent based on natural language input. Further, the processing modules 328 perform task execution based on inferred user intent. In one or more implementations, the DA portion 310 communicates with external services 334 through the network 106 for task completion or information acquisition. The external services interface 332 facilitates such communications.

In one or more implementations, the DA abstraction layer 324 functions as a structured database, which holds actions, entities, queries, and other tools. The operating system process 302 may communicate with the DA abstraction layer 324 to find appropriate tools for completing tasks, using vector searches to retrieve relevant information. This interaction allows the operating system process 302 to adjust dynamically to changing requirements without requiring developer involvement. The DA abstraction layer 324 can operate as a database management system or a specialized data storage system optimized for handling structured data, such as metadata related to app functionalities.

In one or more other implementations, the DA abstraction layer 324 can be implemented on end-user devices (e.g., the electronic devices 110-118). In one or more implementations, the DA abstraction layer 324 is implemented on backend servers or cloud infrastructure, where it can handle tasks such as data processing, tool selection, and communication with the operating system process 302. As illustrated in FIG. 3, the DA abstraction layer 324 is implemented on the DA portion 310. In one or more implementations, mechanisms such as API gateways or service endpoints may be employed to facilitate communication between the operating system process 302 running on the electronic device 110 and the DA abstraction layer 324 running on the DA portion 310.

In one or more implementations, the processing modules 328 in the DA portion 310 includes the following sub-modules, or a subset or superset thereof: input/output processing module, speech-to-text (STT) processing module, natural language processing module, dialogue flow processing module, task flow processing module, service processing module, and speech synthesis processing module. Each of these modules has access to one or more of the following systems or data and models of the DA portion 310, or a subset or superset thereof: ontology, vocabulary index, user data, task flow models, service models, and automatic speech recognition systems.

Embodiments of the subject technology provide for the alignment of actions with entities, creating a structured approach for manipulating information. Mutable entities act as intermediaries between actions and data, allowing direct modification of entity properties. For example, actions such as changing the flag status of a message are associated with message entities, which represent the relevant data. This can enhance the organization and efficiency of information manipulation within software systems. It establishes a systematic connection between actions and the data they operate on, facilitating seamless interaction and manipulation of data entities.

In one or more implementations, the process for establishing updatable entities of an application in the network environment 100 involves initialization, where a compiler running on a server in the network environment 100 (e.g., server 120) prepares to create such entities by configuring parameters for the application. Following initialization, the process can define the characteristics and properties of an entity, specifying its structure and behavior within the application framework. This process can set up data structures, establish communication protocols, and configure access controls to ensure the entity's proper functioning and manageability within the application architecture.

In one or more other implementations, the compiler running on the server 120 may execute a macro to automatically generate app intent calls during compilation of an application. As a result, developers only have to identify properties as updatable, and the compiler can generate app intent calls accordingly (e.g., for modifying the properties), improving efficiency in updating entities. The macro may involve template-based code generation techniques, where predefined patterns or templates are used to generate code based on input parameters or annotations. Developers can annotate properties within a codebase to indicate which entities should be exposed as updatable entities. During compilation, the macro scans the codebase, identifies these annotations, and generates the corresponding app intent calls and associated code automatically. This automation reduces the likelihood of errors and saves developers time by eliminating the need for manual coding of app intent calls.

Once the entity parameters are set, the process can integrate it into the application architecture, checking that it interacts smoothly with other components. This includes checking compatibility and resolving any dependencies to facilitate seamless integration. This integration process involves configuring APIs and middleware to facilitate communication between the new entity and other system components. Additionally, compatibility testing can be conducted to verify that the new entity functions correctly with the existing hardware and software infrastructure.

Referring back to FIG. 2, at block 202, an operating system process (e.g., operating system process 302 of FIG. 3) extracts a schema associated with an application. In one or more implementations, the schema includes metadata that defines a structure indicating at least one entity and at least one app intent call.

In one or more implementations, the operating system process 302 running on the electronic device 110 as shown in FIG. 3 may identify which entities are configured as updatable entities. When an application is installed on the electronic device 110, certain sections of programmable code associated with the compiled application are analyzed by a first process running on the electronic device 110 (e.g., the operating system process 302) to extract the schema, which includes metadata detailing the structure of entities, actions, inputs, outputs, and associated attributes. This schema information may be stored within the application's file system on the electronic device 110 and/or on a storage device accessible to the electronic device 110 and utilized by the operating system process 302. In one or more implementations, the process of extracting schema information during app installation on the electronic device 110 involves the first process analyzing metadata annotations to identify relevant data structures, function definitions, and variable declarations. This schema information can then be parsed and organized into a structured format, such as a JavaScript Object Notation (JSON) file or eXtensible Markup Language (XML) file, which can be stored alongside the compiled app binary. During runtime, the operating system process 302 can access this schema information to understand the app's capabilities and functionalities.

In one or more implementations, this schema information is compiled and stored during the app build process performed on a server (e.g., the server 120), allowing the operating system process 302 to use the schema information to generate data structures or representations of all app capabilities that can be efficiently accessed and utilized by the electronic device 110 at runtime. This static knowledge of app schemas may involve the use of metadata files or configuration files that describe the structure and capabilities of the app. Additionally, techniques such as caching may be employed to optimize the retrieval and storage of this schema information, facilitating quick access and minimal performance overhead during runtime operation.

The operating system process 302 can parse and analyze the metadata to identify the entities and associated app intent calls in the structure. The structure defined in the metadata can include actions similar to function calls and data elements like entities, each with its own framework. The metadata associated with the app intent calls may include details such as parameter types, allowed values, and expected behavior. In one or more implementations, these entities follow a hierarchical arrangement. In one or more other implementations, these entities exist independently. The structure can differ depending on the context. For example, some entities, like airplane mode settings, have a flat structure without complex hierarchies. Conversely, applications such as note-taking apps have hierarchical arrangements, similar to a tree structure. For example, folders contain notes, which may also contain attachments, establishing a hierarchical relationship among the entities. In one or more implementations, the operating system process 302 can determine the structure of updatable entities by analyzing the relationships and dependencies between different data elements within the schema.

In one or more other implementations, the operating system process 302 may execute one or more command-line utilities to obtain insights into the schema, along with metadata indicating update capability. These command-line utilities can provide visibility into the internal structure of the app and aid in understanding its functionalities. In one or more implementations, these command-line utilities may include tools or scripts that parse and analyze the application source code or metadata to extract information about the schema, including entities, attributes, and update capabilities. The metadata indicating update capability may include annotations or comments within the source code, or specific tags or attributes within the metadata.

Referring back to FIG. 2, at block 204, the apparatus determines that the metadata indicates that a property associated with the at least one entity is updateable. In one or more implementations, the operating system process 302 searches within the schema to find app intent calls, creating a framework to explicitly define updatable entities and their associated actions. Entities that do not have corresponding app intent calls capable of updates may be ignored. Properties often represent the state or attributes of an object within the application's data model. These properties can be accessed and manipulated using GET and SET operations, providing a way to retrieve or modify the object's state. While app intent calls handle actions or operations that change the state of entities, properties allow for accessing and retrieving the current state of entities without modifying them.

In one or more implementations, this process performed by the operating system process 302 may involve parsing the metadata or configuration files associated with the application to identify app intent call definitions and their relationships with entities. The operating system process 302 may then compare these app intent call definitions with a list of updatable entities to determine which entities have associated app intent calls for updates. In one or more other implementations, this schema information can facilitate identifying those relevant entities tagged for updates, optimizing system performance and resource utilization.

In one or more implementations, the operating system process 302 can analyze entities and their properties, deducing which are updatable. In one or more other implementations, the operating system process 302 may utilize advanced parsing algorithms that analyze the structure and semantics of the schema, including its entities and properties. By identifying patterns and relationships within the schema, the operating system process 302 can infer additional relationships between entities and app intent calls. In one or more implementations, the operating system process 302 may incorporate machine learning or natural language processing techniques to improve its ability to recognize and generate relevant mappings based on the schema and updateable entity tagging.

To determine if an entity is tagged as updateable, the operating system process 302 can perform one or more scans through the schema. These scans involve analyzing the entity's properties to identify update support and find the corresponding entity updater such as the app intent call. Furthermore, the scans may be conducted by the operating system process 302 to determine which entities a specific app intent call updates. This scan allows for examination of connections between entities and corresponding app intent calls. In one or more implementations, these scans can involve inspecting metadata or configuration files associated with the entities and app intent calls to determine their relationships and capabilities. This schema information can then be used to generate data structures or mappings that facilitate efficient lookup and retrieval by an automated intelligent assistant (e.g., DA portion 310) during runtime.

Entities can be linked with different attributes to represent the components of the structure visible externally from the application and mark them as updatable. For example, the structure may indicate a connection between an application button and a particular attribute on an entity, acting as the main updater for the purpose of that attribute. In this regard, the structure may define a reference from the app intent call to the entity being updated and the value to be assigned to the entity.

Referring back to FIG. 2, at block 206, the apparatus generates a mapping between the property and the at least one app intent call to indicate a relationship between an action taken by the at least one app intent call to enable modification of the property. In one or more implementations, the app intent call functions by directly linking it to a pertinent property on an entity, signaling its role in updating. For example, a binding may designate the entity's name property as updateable. The schema may include an entity reference alongside a new value for the specified property. When executed, the app intent call can adjust or modify the corresponding property of the entity as specified. By establishing a direct link between actions taken by the app intent calls and entities, this feature facilitates accurate task execution, ensuring consistency between user intent and system action. In one or more other implementations, these bindings can provide links between user commands and system responses, facilitating operation by the DA portion 310. Unlike developers who may understand associations based on context, the DA portion 310 may depend on clear connections to perform the property modification tasks accurately. These connections facilitate the operational efficiency of the DA portion 310 to perform dynamic property modification through the updateable entity tagging.

Once a connection between the property and app intent call is identified, modifications can be executed, enabling relative adjustments such as toggling or adjusting parameters by a specific percentage. While users could manually perform similar actions previously, embodiments of the subject technology streamlines and formalizes the process, making it accessible to developers and/or digital assistants through the operating system process 302. In legacy approaches, developers perform such update tasks in an ad hoc manner, relying on intuition rather than a structured approach. In one or more other implementations, explicitly linking the “get” and “set” actions and marking properties as updatable represents a significant enhancement of property modification. With an explicit connection established, both developers and automated assistants can efficiently utilize it. The link between the property and app intent call can be stored within a metadata file, typically formatted as JSON, making it accessible and indexable. The metadata file may contain information such as property names, data types, update methods, and access controls, allowing the operating system process 302 to understand and cause property modifications to be executed accurately. Additionally, the JSON format provides a standardized and machine-readable structure for storing metadata, facilitating easy retrieval and processing by other software components in the DA portion 310 and/or the electronic device 110.

In one or more implementations, a single property can be tagged as updateable, leading to a one-to-one correspondence between an app intent call and a property. In one or more other implementations, multiple properties of an entity can be updated at once by mapping an app intent call to these properties, improving operational efficiency in situations necessitating updates to multiple properties simultaneously. For example, marking an email as read and flagging it blue could be accomplished with a single user request, simplifying the process and minimizing overhead compared to executing separate property updates. This functionality may involve batch processing mechanisms, where multiple property updates are grouped together and executed as a single transaction to minimize latency and improve performance.

Referring back to FIG. 2, at block 208, the operating system process 302 generates a dictionary structure comprising an indication of the mapping between the property and the at least one app intent call. The dictionary structure generated during preprocessing may serve as a repository of information about app intent calls and their associated properties. In one or more implementations, the dictionary structure is generated in conjunction with installation of an application on the electronic device 110.

In one or more other implementations, the dictionary structure and its entries may be used for training on certain intents, which involves training a neural network (or machine learning model) on specific intents. This topic, although related to app intents, does not directly concern updatable entities. In one or more implementations, the DA abstraction layer 324 may be trained on specific intent structures and entity types, including parameters, to achieve high accuracy and effectiveness. In one or more implementations, training the DA abstraction layer 324 on specific intents involves using machine learning algorithms to analyze and categorize data related to user intents. This process typically includes preprocessing the data, selecting appropriate features, and training the model using supervised or unsupervised learning techniques.

Referring back to FIG. 2, at block 210, the apparatus provides the dictionary structure for access by an automated assistant (e.g., digital assistant; DA portion 310 of FIG. 3). In one or more implementations, a second process running on the DA portion 310 (e.g., DA abstraction layer 324) utilizes this dictionary structure to execute property modification tasks. The DA abstraction layer 324 may perform the property modification by accessing the indication of the mapping in the dictionary structure. The DA abstraction layer 324 may retrieve the dictionary structure from storage (e.g., data and models 330) and index the mapping in the dictionary structure.

In one or more other implementations, the DA abstraction layer 324 may perform relative modifications. Once the mapping indicating a connection between a GET operation and a SET operation is established, the connection is definite rather than speculative. For example, if the property is Boolean, with values true or false, the SET operation allows toggling between these states. Similarly, the GET operation retrieves the current state. Expanding on these basic operations, additional functionalities like toggling, increasing, or decreasing can be incorporated. The DA abstraction layer 324 may perform these relative modifications in various scenarios, such as adjusting volume levels or modifying text content. In one or more other implementations, the DA abstraction layer 324 may perform relative modifications by defining and implementing functions or methods that perform specific actions on the property's value using a predefined property value. For example, a toggle function may change a Boolean property from true to false or vice versa. Similarly, functions for increasing or decreasing numeric properties would modify the property's value accordingly to the predefined property value.

By allowing external processes such as the automated intelligent assistant to make unexpected modifications to these entities, the process of automating dynamic property modifications is realized. In this regard, enabling the external process to autonomously perform property modifications without relying on intermediary commands or subprocesses is facilitated by the tagging of updatable entities. This gives the external process the ability to carry out property modifications while maintaining a defined and reliable relationship between the “get” and “set” actions, thus eliminating the need for human intervention.

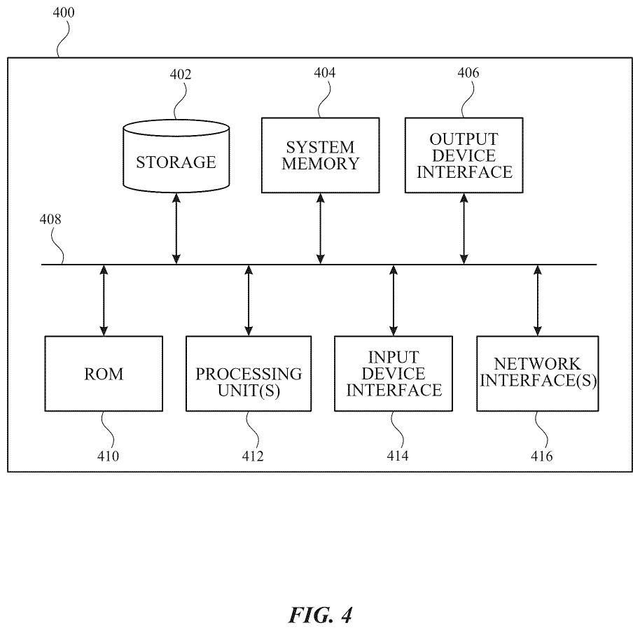

FIG. 4 illustrates an electronic system 400 with which one or more implementations of the subject technology may be implemented. The electronic system 400 can be, and/or can be a part of, any one of the electronic devices 110-118 and/or the server 120 shown in FIG. 1, the operating system process 302 and/or the DA portion 310 shown in FIG. 3. The electronic system 400 may include various types of computer readable media and interfaces for various other types of computer readable media. The electronic system 400 includes a bus 408, one or more processing unit(s) 412, a system memory 404 (and/or buffer), a ROM 410, a permanent storage device 402, an input device interface 414, an output device interface 406, and one or more network interfaces 416, or subsets and variations thereof.

The bus 408 collectively represents all system, peripheral, and chipset buses that communicatively connect the numerous internal devices of the electronic system 400. In one or more implementations, the bus 408 communicatively connects the one or more processing unit(s) 412 with the ROM 410, the system memory 404, and the permanent storage device 402. From these various memory units, the one or more processing unit(s) 412 retrieves instructions to execute and data to process in order to execute the processes of the subject disclosure. The one or more processing unit(s) 412 can be a single processor or a multi-core processor in different implementations.

The ROM 410 stores static data and instructions that are needed by the one or more processing unit(s) 412 and other modules of the electronic system 400. The permanent storage device 402, on the other hand, may be a read-and-write memory device. The permanent storage device 402 may be a non-volatile memory unit that stores instructions and data even when the electronic system 400 is off. In one or more implementations, a mass-storage device (such as a magnetic or optical disk and its corresponding disk drive) may be used as the permanent storage device 402.

In one or more implementations, a removable storage device (such as a flash drive, and its corresponding solid state drive) may be used as the permanent storage device 402. Like the permanent storage device 402, the system memory 404 may be a read-and-write memory device. However, unlike the permanent storage device 402, the system memory 404 may be a volatile read-and-write memory, such as random access memory. The system memory 404 may store any of the instructions and data that one or more processing unit(s) 412 may need at runtime. In one or more implementations, the processes of the subject disclosure are stored in the system memory 404, the permanent storage device 402, and/or the ROM 410. From these various memory units, the one or more processing unit(s) 412 retrieves instructions to execute and data to process in order to execute the processes of one or more implementations.

The bus 408 also connects to the input device interface 414 and output device interface 406. The input device interface 414 enables a user to communicate information and select commands to the electronic system 400. Input devices that may be used with the input device interface 414 may include, for example, alphanumeric keyboards and pointing devices (also called “cursor control devices”). The output device interface 406 may enable, for example, the display of images generated by electronic system 400. Output devices that may be used with the output device interface 406 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 4, the bus 408 also couples the electronic system 400 to one or more networks and/or to one or more network nodes, such as the electronic device 110 shown in FIG. 1, through the one or more network interface(s) 416. In this manner, the electronic system 400 can be a part of a network of computers (such as a LAN, a wide area network (“WAN”), or an Intranet, or a network of networks, such as the Internet. Any or all components of the electronic system 400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
extracting, by a first process running on an electronic device, a schema associated with an application, the schema comprising metadata that defines a structure indicating at least one entity and at least one app intent call;
determining, by the first process, that the metadata indicates that a property associated with the at least one entity is updateable;
generating, by the first process, a mapping between the property and the at least one app intent call to indicate a relationship between an action taken by the at least one app intent call to enable modification of the property;
generating, by the first process, a dictionary structure comprising an indication of the mapping between the property and the at least one app intent call; and
providing, by the first process, the dictionary structure for access by an automated assistant.

2. The method of claim 1, wherein the automated assistant causes modification of the property by accessing the indication of the mapping in the dictionary structure.

3. The method of claim 1, wherein generating the mapping comprises identifying a get operation associated with the property and a set operation associated with the action taken by the at least one app intent call, wherein the mapping comprises a link between the get operation and the set operation.

4. The method of claim 1, wherein the dictionary structure is generated in conjunction with installation of the application on the electronic device.

5. The method of claim 1, wherein determining that the metadata indicates that the property associated with the at least one entity is updateable comprises performing a search through the schema to identify the at least one app intent call that is configured to modify the entity.

6. The method of claim 1, wherein causing modification of the property comprises retrieving the dictionary structure from storage and indexing the mapping in the dictionary structure.

7. The method of claim 1, wherein causing modification of the property comprises executing a second process associated with the automated assistant, wherein the property is modified by the second process.

8. The method of claim 1, wherein causing modification of the property comprises performing, by the first process, a relative property modification using a predefined property value.

9. A device, comprising:
a memory; and
one or more processors configured to:
analyze application code of an application to extract a schema associated with the application, the schema comprising metadata that defines a structure indicating at least one entity and at least one app intent;
determine that the metadata indicates that a property associated with the at least one entity is updateable;
determine a link between the property and the at least one app intent to indicate a relationship between an action taken by the at least one app intent to enable dynamic modification of the property;
generate a dictionary structure comprising an indication of the link between the property and the at least one app intent; and
provide the dictionary structure for access by an automated assistant.

10. The device of claim 9, wherein the automated assistant causes modification of the property by accessing the indication of the link in the dictionary structure.

11. The device of claim 9, wherein the one or more processors configured to determine the link are further configured to identify a get operation associated with the property and a set operation associated with the action taken by the at least one app intent call, wherein the link indicates a relationship between the get operation and the set operation.

12. The device of claim 9, wherein the dictionary structure is generated in conjunction with installation of the application on an electronic device.

13. The device of claim 9, wherein the one or more processors configured to determine that the metadata indicates that the property associated with the at least one entity is updateable are further configured to perform a search through the schema to identify the at least one app intent call that is configured to modify the entity.

14. The device of claim 9, wherein the one or more processors configured to cause modification of the property are further configured to retrieve the dictionary structure from storage and index the link in the dictionary structure.

15. The device of claim 9, wherein the one or more processors configured to cause modification of the property are further configured to execute a second process associated with the automated assistant, wherein the property is modified by the second process.

16. A non-transitory machine-readable medium comprising code that, when executed by a processor, causes the processor to perform operations comprising:
determining a schema associated with an application by compiling application code of the application, the schema comprising metadata that defines a structure indicating at least one entity and at least one app intent;
determining that the metadata indicates that a property associated with the at least one entity is updateable;
generating a mapping between the property and the at least one app intent to indicate a relationship between an action taken by the at least one app intent to enable modification of the property;
generating a dictionary structure comprising an indication of the mapping between the property and the at least one app intent; and
providing the dictionary structure for access by an automated assistant.

17. The non-transitory machine-readable medium of claim 16, wherein the automated assistant causes modification of the property by accessing the indication of the mapping in the dictionary structure.

18. The non-transitory machine-readable medium of claim 16, wherein generating the mapping comprises identifying a get operation associated with the property and a set operation associated with the action taken by the at least one app intent call, wherein the mapping comprises a link between the get operation and the set operation.

19. The non-transitory machine-readable medium of claim 16, wherein the dictionary structure is generated in conjunction with installation of the application on an electronic device.

20. The non-transitory machine-readable medium of claim 16, wherein determining that the metadata indicates that the property associated with the at least one entity is updateable comprises performing a search through the schema to identify the at least one app intent call that is configured to modify the entity.
